(19) United States
(12) Patent Application Publication
(10) Pub. No.: US 2009/0043067 A1
(43) Pub. Date: Feb. 12, 2009

(54) PROCESS FOR PRODUCING LENS, AND LENS

(75) Inventor: Kensuke MORITA, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/134,418

(22) Filed: Jun. 6, 2008

(30) Foreign Application Priority Data
Aug. 10, 2007 (JP) 2007-209792

(51) Int. Cl. C08G 77/20

(52) U.S. Cl. 528/32

(57) ABSTRACT

A process for producing a lens is provided that includes a step of preparing a silicone resin composition that includes an organopolysiloxane containing a constituent unit represented by Formula (I), and a step of curing the silicone resin composition in a mold at a temperature of at least 220° C. There is also provided a lens produced by the production process.

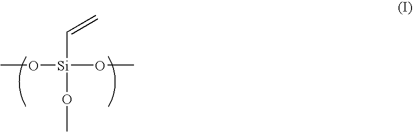

### BACKGROUND OF THE INVENTION

1. Field of the Invention

The present invention relates to a process for producing a lens, and a lens.

2. Description on the Related Art

Lenses of camera-equipped mobile phones and lenses for LEDs are conventionally produced using a thermoplastic resin such as an acrylic resin or a polycarbonate resin, but due to the higher luminance of light sources and the higher temperature of soldering processes in recent years the conventional thermoplastic resin lenses suffer from problems such as deformation and yellow coloration due to high temperature.

Under such circumstances, a large number of attempts have been made to use a silicone resin in a lens where heat resistance is required (JP-A-2007-8996, JP-A-2007-38443, and JP-A-2006-335845, JP-A denotes a Japanese unexamined patent application publication). In this case, in general, a composition comprising A) a compound having a vinyl group bonded to a silicon atom, B) a compound having a hydrogen atom bonded to a silicon atom, and C) a platinum catalyst is cured at a temperature of no greater than 150° C., but when such a cured material is exposed to UV radiation or heat, the platinum catalyst in the cured material is colored by UV rays or heating, and the cured material turns brown or yellow, which is a problem.

Furthermore, since a composition comprising all of A), B), and C) undergoes curing at room temperature, it is necessary to prepare it by mixing 2 types of liquids comprising 1 or 2 of A), B), and C) immediately before use, and this causes a problem in terms of production.

### BRIEF SUMMARY OF THE INVENTION

It is an object of the present invention to provide a process for producing a lens having heat resistance to at least 300° C. and having excellent transparency and uniformity, and a lens.

This object has been attained by the following means.

(1) A process for producing a lens, the process comprising a step of preparing a silicone resin composition comprising an organopolysiloxane containing a constituent unit represented by Formula (I) and a step of curing the silicone resin composition in a mold at a temperature of at least 220° C.,

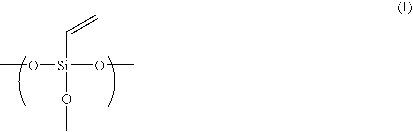

(2) the process for producing a lens according to (1), wherein at least 3 mol % of the silicon atoms contained in the organopolysiloxane are silicon atoms contained in the constituent unit represented by Formula (I),
(3) the process for producing a lens according to (1) or (2), wherein at least 30 mol % of the vinyl groups contained in the organopolysiloxane are vinyl groups contained in the constituent unit represented by Formula (I),
(4) the process for producing a lens according to any one of (1) to (3), wherein the organopolysiloxane is represented by Compositional Formula (A),

R¹ₐR²_{b}SiO_{(4-a-b)/2} (A)

(in Formula (A), R¹ denotes a vinyl group, R² denotes independently unsubstituted or substituted monovalent hydrocarbon groups (excluding a vinyl group), a is 0.03 to 0.50, and a+b is 0.5 to 1.20),
(5) the process for producing a lens according to any one of (1) to (4), wherein the organopolysiloxane has a glass transition temperature of 110° C. to 310° C., and
(6) a lens produced by the production process according to any one of (1) to (5).

### DETAILED DESCRIPTION OF THE INVENTION

The process for producing a lens of the present invention comprises a step of preparing a silicone resin composition comprising an organopolysiloxane containing a constituent unit represented by Formula (I), and a step of curing the silicone resin composition in a mold at a temperature of at least 220° C.

The process for producing a lens of the present invention is explained in detail below.

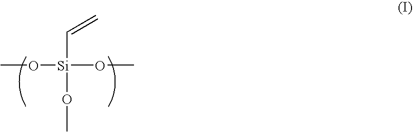

The step of preparing a silicone resin composition comprising an organopolysiloxane containing a constituent unit represented by Formula (I) is explained below.

Prior to curing, the silicone resin composition used in the process for producing a lens of the present invention (hereinafter, also called the ‘silicone resin composition of the present invention’) comprises an organopolysiloxane having a constituent unit represented by Formula (I), and it is preferable for at least 3 mol % of the silicon atoms contained in the organopolysiloxane to be silicon atoms contained in the constituent unit represented by Formula (I). Furthermore, the silicon atoms contained in the constituent unit are more preferably 3 to 50 mol % of the silicon atoms contained in the organopolysiloxane, yet more preferably 5 to 40 mol %, and most preferably 7 to 30 mol %. When within the range of the above numerical values, a balance can be achieved between the curability of the silicone resin composition, the hardness of a lens obtained by curing, and the heat resistance.

Hereinafter, unless otherwise specified, the range for a numerical value stated to be ‘3 to 50 mol %’, etc. means ‘at least 3 mol % but no greater than 50 mol %’, etc., and this applies to ranges for other numerical values.

In the present invention, among vinyl groups contained in the organopolysiloxane, at least 30 mol % are preferably vinyl groups contained in the constituent unit represented by Formula (I), more preferably at least 50 mol %, and yet more preferably at least 70 mol %, and it is most preferable for all of the vinyl groups contained in the organopolysiloxane to be vinyl groups contained in the constituent unit represented by Formula (I).

In the present invention, the organopolysiloxane preferably comprises a constituent unit represented by Formula (II).

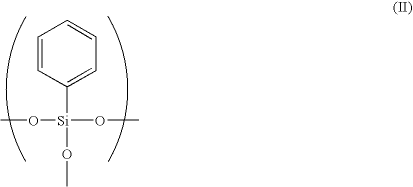

It is preferable for it to comprise the constituent unit represented by Formula (II) since a lens having a high refractive index can be obtained. It is preferable to use a material having a high refractive index since the degree of freedom in designing a lens becomes high, for example, the thickness of an optical lens can be reduced.

It is preferable for 30 to 95 mol % of the silicon atoms contained in the organopolysiloxane to be silicon atoms contained in the constituent unit represented by Formula (II), more preferably 40 to 90 mol %, and most preferably 50 to 85 mol %. It is preferable for the numerical values to be in the above range since a sufficient refractive index can be obtained, and a lens having excellent transparency and physical strength can be obtained.

In the present invention, the organopolysiloxane may have a constituent unit other than the constituent units represented by Formula (I) and Formula (II). Specific examples of the constituent unit other than the constituent units represented by Formula (I) and Formula (II) include siloxane, monomethylsiloxane, monoethylsiloxane, divinylsiloxane, phenylvinylsiloxane, methylphenylsiloxane, diphenylsiloxane, dimethylsiloxane, trivinylsiloxane, divinylmethylsiloxane, divinylphenylsiloxane, vinyidimethylsiloxane, vinylphenylmethylsiloxane, trimethylsiloxane, dimethylphenylsiloxane, methyldiphenylsiloxane, triphenylsiloxane, methylvinylsiloxane, and siloxanes in which at least one hydrogen atom of an organic group of these siloxane constituent units is substituted by a halogen atom, etc.

The organopolysiloxane contained in the silicone resin composition of the present invention is preferably a compound represented by Compositional Formula (A).

R¹ₐR²_{b}SiO_{(4-a-b)/2} (A)

(In Formula (A), R¹ denotes a vinyl group, R² denotes independently unsubstituted or substituted monovalent hydrocarbon groups (excluding a vinyl group), a is 0.01 to 3, and b is 0 to 2.99.)

Examples of R² in Compositional Formula (A) include, independently from each other, a monovalent hydrocarbon group including an alkyl group having 1 to 3 carbons such as a methyl group, an ethyl group, or a propyl group and an aryl group having 6 to 12 carbons such as a phenyl group or a tolyl group, and a halogen atom-substituted monovalent hydrocarbon group of the above type, and among them a methyl group and a phenyl group are preferable.

a denotes the average number of vinyl groups per silicon atom in the organopolysiloxane; specifically, it is preferably 0.03 to 0.50, more preferably 0.05 to 0.40, and most preferably 0.07 to 0.30. When a is a numerical value in the above range, a lens having good curability, shape, heat resistance, and mechanical strength can be obtained.

a+b is preferably 0.5 to 1.2, more preferably 0.6 to 1.15, and most preferably 0.7 to 1.1. When a+b is a numerical value in the above range, the silicone resin composition prior to curing has a viscosity and phase transition temperature suitable for thermal molding, and a lens after curing has excellent heat resistance.

The compound represented by Compositional Formula (A) is preferably represented by Compositional Formula (B).

Vi_{c}Ph_{d}MeₑSiO_{(4-c-d-e)/2} (B)

(In Formula (B), Vi denotes a vinyl group, Ph denotes a phenyl group, Me denotes a methyl group, c is 0.01 to 3, d is 0 to 2.99, and e is 0 to 2.99.)

In Compositional Formula (B), a preferred range for c is the same as the preferred range for a described above, and a preferred range for c+d+e is the same as the preferred range for a+b described above.

d is preferably 0.1 to 1.3, more preferably 0.4 to 0.9, and most preferably 0.5 to 0.85. When d is a numerical value in this range, the lens of the present invention can attain a sufficiently high refractive index from the point of view of optical performance.

The organopolysiloxane contained in the silicone resin composition of the present invention preferably has a three-dimensional network structure.

The polystyrene-basis weight-average molecular weight by gel permeation chromatography of the organopolysiloxane contained in the silicone resin composition of the present invention is preferably 3,500 to 200,000, more preferably 4,000 to 100,000, and most preferably 4,500 to 50,000.

The polystyrene-basis number-average molecular weight by gel permeation chromatography of the organopolysiloxane contained in the silicone resin composition of the present invention is preferably 1,500 to 15,000, more preferably 2,000 to 10,000, and most preferably 2,500 to 8,000.

When the weight-average molecular weight and the number-average molecular weight are numerical values in the above ranges, the silicone resin composition of the present invention has a viscosity, phase transition temperature, and heat resistance suitable for thermal molding.

The organopolysiloxane may be obtained by a method involving cohydrolysis-condensation of a mixture of at least two types of organohalosilane and/or organoalkoxysilane corresponding to the respective siloxane constituent units.

In the present invention, it is preferable to carry out cohydrolysis-condensation using an organohalosilane, and it is particularly preferable to use an organochlorosilane. That is, the organopolysiloxane preferably does not have a silicon functional group such as a hydroxy group or alkoxy group directly bonded to a silicon atom. A lens produced using an organopolysiloxane having no silicon functional group is preferable since it is chemically stable and has excellent heat resistance.

The organopolysiloxane having no silicon functional group may be produced by treating a polyorganosiloxane obtained by cohydrolysis-condensation of organochlorosilanes corresponding to the respective siloxane unit structures with an alkaline substance such as potassium hydroxide or potassium silanolate, and further treating it with a silylating agent as necessary.

As the silylating agent, a known agent may be used, and specific examples thereof include, but are not limited to, hexamethyldisilazane (HMDS), dimethyldichlorosilane (DMCS), trimethylchlorosilane (TMCS), N-trimethylsilylacetamide (TMSA), N,O-bis(trimethylsilyl)acetamide (BSA), N-methyl-N-trimethylsilylacetamide (MTMSA), N-methyl-N-trimethylsilyltrifluoroacetamide (MSTFA), N-trimethylsilyldimethylamine (TMSDMA), N-trimethylsilyldiethylamine (TMSDEA), N,O-bis(trimethylsilyl)trifluoroacetamide (BSTFA), N-trimethylsilylimidazole (TMSI), tetramethyldisilazane (TMDS), tert-butyldimethylchlorosilane (tert-BDMCS), N-methyl-N-(tert-butyldimethylsilyl)trifluoroacetamide (MTBSTFA), dichloromethyltetramethyldisilazane (CMTMDS), chloromethyldimethyldichlorosilane (CMDMCS), bromomethyldimethylchlorosilane (BMDMCS), flophemesylamine, flophemesyl chloride, flophemesyldiethylamine, 1,1-divinyl-1,1,3,3-tetramethyldisilazane, 1,1-divinyl-1,1,3,3-tetramethyldisiloxane, hexamethyldisiloxane, hexavinyldisiloxane, dimethylvinylchlorosilane, and trivinylchlorosilane, and among them hexamethyldisilazane, hexamethyldisiloxane, dimethylvinylchlorosilane, and trimethylchlorosilane are preferable.

Furthermore, the organopolysiloxane contained in the silicone resin composition of the present invention may be produced by mixing two or more types of organopolysiloxanes obtained separately by hydrolysis-condensation.

As described above, the organopolysiloxane contained in the silicone resin composition of the present invention preferably does not contain the above-mentioned silicon functional group, but it may contain the above-mentioned silicon functional group in a range that does not impair the effects of the present invention.

The silicone resin composition of the present invention preferably comprises a mold-release agent.

As the mold-release agent, a known agent may be used and, although not limited thereto, fatty acid-based compound and erythritol derivative fatty acid ester mold-release agents are excellent in terms of compatibility with a silicone resin, transparency after curing, and discoloration resistance after being left to stand at high temperature.

Specific examples thereof include pentaerythritol tetrastearate, dipentaerythritol adipate stearate, glycerol tri-18-hydroxystearate, pentaerythritol full stearate, polyethylene oxide, highly esterified carnauba, RIKEMAL TG-12 (glycerol tri-18-hydroxystearate), RIKESTER EW440A (pentaerythritol tetrastearate), LICOWAX PED136 (polyethylene oxide), Electol D-12141 (polypropylene/maleic anhydride copolymer), RIKESTER EW-200 (pentaerythritol adipate stearate), and RIKESTER EW400 (pentaerythritol full stearate), and among them pentaerythritol tetrastearate can preferably be used.

The mold-release agent is preferably contained at 0.05 to 5 wt % relative to the overall amount of the silicone resin composition, and more preferably 0.1 to 2 wt %. When the numerical value is within the above range, a lens molded by injection molding, etc. can easily be taken out of a mold.

A polymerization inhibitor (4-methoxyphenol, catechol, etc.) may be added to the silicone resin composition of the present invention or a reaction mixture during production of the silicone resin composition.

It is preferable for neither an SiH group nor a platinum catalyst to be contained from the viewpoint of stability of the silicone resin composition and a cured material such as a lens. However, as long as the effects of the present invention are not impaired, they may be contained.

The silicone resin composition of the present invention may comprise an additive described in known references such as Patent Publications 1 to 3 as long as the performance is not impaired.

The silicone resin composition of the present invention is preferably in a solid state at 25° C. When the silicone resin composition of the present invention is in a solid state at 25° C., it is preferably molded in a state given flowability by heating.

The glass transition temperature (Tg) of the silicone resin composition is preferably 110° C. to 310° C., more preferably 120° C. to 270° C., and most preferably 130° C. to 230° C.

The melting point of the silicone resin composition is preferably at least 180° C., more preferably at least 220° C., and most preferably at least 250° C.

If the melting point is in the above range, when the silicone resin composition is thermally cured, a balance between good moldability and curability can be achieved.

The total acid number of the silicone resin composition of the present invention in accordance with JIS K2501 (1992) is 0.0001 to 0.2 mg·KOH/g, and preferably 0.0001 to 0.040 mg·KOH/g. When the total acid number is a numerical value in the above range, since a cured material such as a lens formed by curing the silicone resin composition of the present invention does not greatly discolor during heating, it is possible to suppress degradation in light transmittance. In particular, in order to reduce the degradation in light transmittance in a short wavelength region of a cured material such as a lens after heating, the total acid number is most preferably in the range of 0.0001 to 0.010 mg·KOH/g.

In order to make the acid number be in the above range, as a specific method for removing an acidic substance, when an organopolysiloxane is produced by hydrolyzing an organochlorosilane, it is preferable to carry out a treatment with a strong base after the hydrolysis reaction of the organochlorosilane.

This is because, when hydrolysis is carried out only by adding water, many silicon atom-bonded chlorines remain. Furthermore, for neutralization of the strong base added, it is preferable to use a volatile acidic substance. This is because excess volatile acidic substance can be removed easily by distillation, etc. A salt thus formed may be removed by washing with water.

Moreover, when an organopolysiloxane is produced by hydrolysis of an alkoxysilane using an acidic substance as an acidic catalyst, in order to remove the acidic catalyst used, washing well with water is preferable. Since these acidic substances are soluble in an organic layer, it is easy for them to remain, and they increase the total acid number of the silicone resin composition in some cases.

A step of curing the silicone resin composition in a mold at a temperature of at least 220° C. is explained below.

The silicone resin composition of the present invention may be molded by various types of molding methods. Since a cured material therefrom is optically transparent, it is particularly useful as an optical lens.

As a molding method, a molding method described in Patent Publications 1 to 3, the textbook ‘Technology and Application of Plastic Lenses’ (CMC Publishing Co., Ltd.), etc. may be used. Specific examples include injection molding, compression molding, cast molding, transfer molding, and coating.

The lens of the present invention is produced by curing as a result of a reaction between vinyl groups by heating the silicone resin composition of the present invention in a mold at a temperature of 220° C. to 450° C.

The heating temperature is preferably 240° C. to 420° C., more preferably 260° C. to 400° C., and most preferably 280° C. to 380° C.

The heating time is generally from 10 sec to 10 hours, preferably 1 min to 5 hours, yet more preferably 3 min to 3 hours, and most preferably 10 min to 1 hour. Heating is preferably carried out in nitrogen.

The process for producing a lens of the present invention preferably comprises a step of further heating a lens obtained (post-cure step). The temperature of the post-cure step is preferably 250° C. to 450° C., and the heating time is preferably on the order of 10 min to 2 hours. It is preferable if the numeral values are in the above ranges since a volatile component can be removed by the post-cure step and a molding with high hardness can be obtained.

It is preferable to carry out molding under conditions such that the ratio of the molding shrinkage after molding to the molding shrinkage after the post-cure is 0.9 to 1.1.

Since the lens of the present invention is optically transparent, it is particularly useful as an optical lens. The ‘optically transparent’ referred to here specifically means that the light transmittance is at least 80%, preferably at least 90%, and more preferably at least 95%. The ‘light transmittance’ here is the transmittance for visible light at a wavelength of 555 nm for a cured material molded at a thickness of 1 mm. A wavelength of 555 nm is a substantially middle value of visible light and is a value known as a wavelength having the highest sensitivity to the human eye.

Furthermore, a lens formed by curing the silicone resin composition of the present invention preferably also has high light transmittance in a short wavelength region. The light transmittance of a 1 mm thick cured material for light at a wavelength of 400 nm is preferably at least 80% in an initial state without an accelerated deterioration test such as a thermal treatment being carried out, more preferably at least 90%, and most preferably at least 95%.

It is known that, in general, lenses containing an organic substance often gradually turn yellow when exposed to high temperature, and with regard to the light transmittance at each wavelength of the colored lenses, the light transmittance at short wavelengths corresponding to blue to purple greatly degrades compared with other visible light regions.

Because of this, the degree of coloration of lenses can be compared by measuring the light transmittance on the short wavelength side, for example, at a wavelength of 400 nm. The allowable level of coloration depends on the intended application and, for example, even after aging at 200° C. for 14 days is carried out, the light transmittance at a wavelength of 400 nm is preferably at least 40%, and more preferably at least 50%.

The lens of the present invention preferably has a ratio of refractive indices measured at 400 nm and 596 nm of at least 1.01.

A cured material of the silicone resin composition of the present invention may be used suitably in a fixed form such as an optical lens, a prism, a light guide plate, a deflection plate, a light guide path, a sheet, or a film, and an indefinite form such as a molding agent, a sealant, a casting agent, a coating agent, an adhesive, or a protecting agent for a semiconductor element in an optical semiconductor, and among them it is preferable to use it as an optical lens.

The lens of the present invention is particularly suitably used as an optical lens that is exposed to a temperature higher than room temperature such as for example 50° C. to 300° C. during a production process or in an application environment or as an optical lens in direct contact with or in proximity to a light source emitting high luminance light. Specifically, the lens of the present invention is particularly useful as an optical lens of a camera built into a mobile phone or an optical lens for an LED.

In accordance with the present invention, there can be provided a process for producing a lens having heat resistance to at least 300° C. and having excellent transparency and uniformity, and a lens.

### EXAMPLES

The present invention is specifically explained below by reference to Examples, but the present invention is not limited to the Examples below. Compositional formulae were obtained from the ratio when prepared and the integration ratio in NMR. Glass transition temperature (Tg) was measured using a melting point apparatus. Unless otherwise specified, ‘parts’ below denotes ‘parts by weight’.

### Synthetic Example 1

33.85 parts of phenyltrichlorosilane, 3.23 parts of vinyltrichlorosilane, and 3.40 parts of tetrachlorosilane were mixed to give an organochlorosilane mixture, and this organochlorosilane mixture was added dropwise over 60 minutes to a mixture containing 20.80 parts of toluene, 9.37 parts of isopropyl alcohol, 0.003 parts of 4-methoxyphenol, and 12 parts of water while keeping the liquid temperature at no greater than 30° C. and stirring vigorously. After stirring for a further 60 minutes, 80 parts of toluene was added thereto, and the mixture was washed with water until the aqueous layer after washing became neutral.

After washing with water, a toluene solution having a siloxane concentration of 10 wt % was prepared, 0.024 parts of potassium hydroxide was added thereto, and polymerization was carried out for 5 hours by heating and refluxing while removing water with a Dean-Stark apparatus. Subsequently, the mixture was concentrated until the solids content concentration became 75 wt %, and refluxing was carried out for a further 3 hours.

Subsequently, 6 parts of trimethylchlorosilane was added thereto, stirring was carried out at room temperature for 60 minutes, the alkali was neutralized, and remaining silanol groups were removed. After filtration, the toluene was removed by distillation at reduced pressure under heating, 156.2 parts of isopropyl alcohol was added thereto, and a precipitate was isolated by decantation. The precipitate thus obtained was dried and ground, thus giving organopolysiloxane A in a solid state.

When the polystyrene-basis molecular weight was measured by gel permeation chromatography, the weight-average molecular weight was 14,800, and the number-average molecular weight was 4,900. The Tg of organopolysiloxane A was 190° C.

### Compositional Formula of Organopolysiloxane A

Vi_{0.10}Me_{0.05}Ph_{0.76}SiO_{1.55}

(Hereinafter, in the compositional formulae, Vi denotes a vinyl group, Me denotes a methyl group, and Ph denotes a phenyl group.)

It was apparent from the ratio when prepared, the compositional formula, and an NMR spectrum that organopolysiloxane A contained a constituent unit of Formula (I).

### Synthetic Example 2

14.80 parts of phenyltrichlorosilane, 2.99 parts of methyltrichlorosilane, 1.61 parts of vinyltrichlorosilane, and 10.40 parts of toluene were mixed to give an organochlorosilane mixture, and this was added dropwise over 60 minutes to 10 parts of water while stirring vigorously and keeping the internal temperature at no greater than 30° C. After stirring was carried out for a further 60 minutes, 30 parts of toluene was added thereto, and the mixture was washed with water until the aqueous layer after washing became neutral. After washing with water, a toluene solution having a siloxane concentration of 25 wt % was prepared, 0.010 parts of potassium hydroxide was added thereto, and polymerization was carried out for 5 hours by heating and refluxing while removing water with a Dean-Stark apparatus. Subsequently, the mixture was concentrated until the solids content concentration became 75 wt %, and refluxing was carried out for a further 3 hours. Subsequently, 3 parts of trimethylchlorosilane was added thereto, stirring was carried out at room temperature for 60 minutes, the alkali was neutralized, and remaining silanol groups were removed. After the liquid was separated and washed, 2.0 parts of a RIKESTER EW-440A fatty acid-based mold-release agent (pentaerythritol tetrastearate, manufactured by Riken Vitamin Co., Ltd.) was added thereto, filtration was carried out, and the toluene was removed by distillation at reduced pressure under heating, thus giving organopolysiloxane B in a solid state.

When the polystyrene-basis molecular weight was measured by gel permeation chromatography, the weight-average molecular weight was 11,000, and the number-average molecular weight was 3,200. The Tg of organopolysiloxane B was 213° C.

### Compositional Formula of Organopolysiloxane B

Vi_{0.10}Me_{0.21}Ph_{0.69}SiO_{1.50}

It was apparent from the ratio when prepared, the compositional formula, and an NMR spectrum that organopolysiloxane B contained a constituent unit of Formula (I).

### Synthetic Example 3

50.77 parts of phenyltrichlorosilane and 9.69 parts of vinyltrichlorosilane were mixed to give an organochlorosilane mixture, and this organochlorosilane mixture was added dropwise over 60 minutes to a mixture containing 30.87 parts of toluene, 13.99 parts of isopropyl alcohol, 0.01 parts of 4-methoxyphenol, and 17.8 parts of water while keeping the mixture temperature at no greater than 30° C. and stirring vigorously. After stirring for a further 60 minutes, 90 parts of toluene was added thereto, and the mixture was washed with water until the aqueous layer after washing became neutral. After washing with water, a toluene solution having a siloxane concentration of 10 wt % was prepared, 0.045 parts of potassium hydroxide was added thereto, and polymerization was carried out for 5 hours by heating and refluxing while removing water with a Dean-Stark apparatus. Subsequently, the mixture was concentrated until the solids content concentration became 75 wt %, and refluxing was carried out for a further 3 hours. Subsequently, 2.0 parts of trimethylchlorosilane was added thereto, stirring was carried out at room temperature for 60 minutes, the alkali was neutralized, and remaining silanol groups were removed. After filtration, the toluene was removed by distillation at reduced pressure under heating, 300 parts of isopropyl alcohol was added thereto, and a precipitate was isolated by decantation, thus giving organopolysiloxane C in a solid state.

When the polystyrene-basis molecular weight was measured by gel permeation chromatography, the weight-average molecular weight was 4,600, and the number-average molecular weight was 2,600. The Tg of organopolysiloxane C was 135° C.

### Compositional Formula of Organopolysiloxane C

Vi_{0.20}Me_{0.01}Ph_{0.8}SiO_{1.50}

It was apparent from the ratio when prepared, the compositional formula, and an NMR spectrum that organopolysiloxane C contained a constituent unit of Formula (I).

### Synthetic Example 4

2 parts of organopolysiloxane A and 2 parts of organopolysiloxane C were dissolved in 40 parts of toluene, and the mixture was concentrated at reduced pressure under heating, thus giving organopolysiloxane D.

When the polystyrene-basis molecular weight was measured by gel permeation chromatography, the weight-average molecular weight was 9,700, and the number-average molecular weight was 3,300. The Tg of organopolysiloxane D was 160° C.

It was apparent from the ratio when prepared, the compositional formula, and an NMR spectrum that organopolysiloxane D contained a constituent unit of Formula (I).

### Synthetic Example 5

41.93 parts of phenyltrichlorosilane, 5.99 parts of methylvinyldichlorosilane, and 5.48 parts of dimethyldichlorosilane were mixed to give an organochlorosilane mixture, and this was added dropwise over 60 minutes to a mixture containing 19.07 parts of toluene, 14 parts of water, and 8.59 parts of isopropyl alcohol while stirring vigorously and keeping the liquid temperature at no greater than 30° C. After stirring for a further 2 hours, an organic layer was isolated by a separatory operation, and the organic layer was washed with water 4 times. 0.024 parts of potassium hydroxide was added thereto, and the mixture was refluxed by heating for 5 hours while removing water with a Dean-Stark apparatus. Subsequently, the mixture was concentrated until the solids content concentration became 75 wt %, and refluxing was carried out for a further 3 hours. The mixture was cooled to room temperature, and 41.96×10⁻⁶ parts of acetic acid was added thereto. After the reaction mixture was filtered, it was concentrated, dried, and ground, thus giving organopolysiloxane E in a solid state.

When the polystyrene-basis molecular weight was measured by gel permeation chromatography, the weight-average molecular weight was 4,000, and the number-average molecular weight was 1,500. The Tg of organopolysiloxane E was 90° C. Compositional formula of organopolysiloxane E

Vi_{0.15}Me_{0.45}Ph_{0.7}SiO_{1.35}

It was apparent from the ratio when prepared, the compositional formula, and an NMR spectrum that organopolysiloxane E did not contain a constituent unit of Formula (I).

When organopolysiloxanes A to E were each stored at 25° C. for 1 month, there was no change in weight-average molecular weight, and they had high storage stability.

### Example 1

Using a silicone resin composition containing organopolysiloxane A on its own, a colorless transparent dome-shaped lens (diameter 3 mm, height 1.8 mm) was injection-molded in nitrogen at a mold temperature of 380° C. with an injection molding pressure of 20 MPa for a molding time of 10 minutes.

### Example 2

Using a silicone resin composition containing organopolysiloxane A on its own, a colorless transparent dome-shaped lens (diameter 3 mm, height 1.8 mm) was injection-molded in nitrogen at a mold temperature of 280° C. with an injection molding pressure of 20 MPa for a molding time of 2 hours.

### Example 3

Using a silicone resin composition containing organopolysiloxane B on its own, a colorless transparent dome-shaped lens (diameter 3 mm, height 1.8 mm) was injection-molded in nitrogen at a mold temperature of 350° C. with an injection molding pressure of 20 MPa for a molding time of 30 minutes.

### Example 4

Using a silicone resin composition containing organopolysiloxane C on its own, a colorless transparent dome-shaped lens (diameter 3 mm, height 1.8 mm) was injection-molded in nitrogen at a mold temperature of 380° C. with an injection molding pressure of 20 MPa for a molding time of 10 minutes.

### Example 5

Using a silicone resin composition containing organopolysiloxane D on its own, a colorless transparent dome-shaped lens (diameter 3 mm, height 1.8 mm) was injection-molded in nitrogen at a mold temperature of 380° C. with an injection molding pressure of 20 MPa for a molding time of 10 minutes.

### Comparative Example 1

Using a silicone resin composition containing organopolysiloxane E on its own, a colorless transparent dome-shaped lens (diameter 3 mm, height 1.8 mm) was injection-molded in nitrogen at a mold temperature of 150° C. with an injection molding pressure of 20 MPa for a molding time of 30 minutes.

### Evaluation of Heat Resistance Temperature

Test pieces were prepared under the same injection molding conditions using the same silicone resin compositions as for the lenses molded in Examples 1 to 5 and Comparative Example 1, and a heat resistance temperature was measured for these test pieces in accordance with a method for measuring deflection under load defined by ASTM D-648. The results are given in Table 1.

Specifically, a load of 1.82 MPa (18.6 kgf/cm²) was applied to the test piece via three points in a thermal bath, and the temperature was increased at 2° C./min. In general, since in so doing the mechanical strength of a measured material decreases, the test piece gradually deflects. The temperature at which this displacement reaches 0.254 mm is defined as the ‘deflection temperature under load’.

TABLE 1

| Examples and Comparative Example | Heat resistance temperature |
|---|---|
| Example 1 | >320° C. |
| Example 2 | >320° C. |
| Example 3 | >320° C. |
| Example 4 | >320° C. |
| Example 5 | >320° C. |
| Comparative Example 1 | 110° C. |

From the results above, it is clear that, in accordance with the use of the production process of the present invention, a lens having high heat resistance can be formed using a silicone resin composition having excellent storage stability. Furthermore, all of the lenses obtained in Examples 1 to 5 had excellent transparency and uniformity.

What is claimed is:

1. A process for producing a lens, the process comprising:
a step of preparing a silicone resin composition comprising an organopolysiloxane containing a constituent unit represented by Formula (I); and
a step of curing the silicone resin composition in a mold at a temperature of at least 220° C.

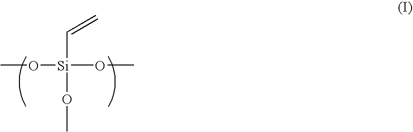

2. The process for producing a lens according to claim 1, wherein at least 3 mol % of the silicon atoms contained in the organopolysiloxane are silicon atoms contained in the constituent unit represented by Formula (I).

3. The process for producing a lens according to claim 1, wherein at least 30 mol % of the vinyl groups contained in the organopolysiloxane are vinyl groups contained in the constituent unit represented by Formula (I).

4. The process for producing a lens according to claim 1, wherein the organopolysiloxane is represented by Compositional Formula (A),
R¹ₐR²_{b}SiO_{(4-a-b)/2} (A)
(in Formula (A), R¹ denotes a vinyl group, R² denotes independently unsubstituted or substituted monovalent hydrocarbon groups (excluding a vinyl group), a is 0.03 to 0.50, and a+b is 0.5 to 1.20.)

5. The process for producing a lens according to claim 1, wherein the organopolysiloxane is represented by Compositional Formula (B),
Vi_{c}Ph_{d}MeₑSiO_{(4-c-d-e)/2} (B)
(in Formula (B), Vi denotes a vinyl group, Ph denotes a phenyl group, Me denotes a methyl group, c is 0.01 to 3, d is 0 to 2.99, and e is 0 to 2.99.)

6. The process for producing a lens according to claim 1, wherein the organopolysiloxane has a glass transition temperature of 110° C. to 310° C.

7. The process for producing a lens according to claim 1, wherein 30 to 95 mol % of the silicon atoms contained in the organopolysiloxane are silicon atoms contained in a constituent unit represented by Formula (II).

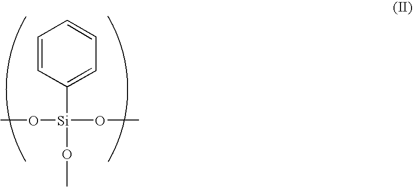

8. A lens produced by the production process according to claim 1.
